(19) United States
(12) Patent Application Publication
(10) Pub. No.: US 2018/0300305 A1
(43) Pub. Date: Oct. 18, 2018

(54) Shared Templates In A Collaborative Work Environment

(71) Applicant: Microsoft Technology Licensing, LLC, Redmond, WA (US)

(72) Inventors: Wing Hong Michael Lam, Issaquah, WA (US); Anand Prakash, Bothell, WA (US)

(73) Assignee: Microsoft Technology Licensing, LLC, Redmond, WA (US)

(21) Appl. No.: 15/583,403

(22) Filed: May 1, 2017

Related U.S. Application Data
(60) Provisional application No. 62/486,431, filed on Apr. 17, 2017.

(51) Int. Cl. G06F 17/24; G06F 17/22; G06F 17/30

(52) U.S. Cl. CPC G06F 17/248; G06F 17/2205; G06F 3/0482; G06F 17/30312; G06F 17/30165; G06F 17/2288

(57) ABSTRACT

Described herein are systems and methods for providing one or more shared templates to a tenant or to a team associated with a tenant. A shared template is a pre-defined data structure that includes one or more elements related to a particular task. The template can assist a team in communicating about the task, working on the task, tracking the progress of the task, and/or completing the task. The shared template(s) can be stored on a global repository or on a tenant repository. In aspects, multiple users (e.g., tenants) can access the shared template(s) stored on the global repository while the members of a team associated with the tenant may access the shared template(s) on the tenant repository. A shared template may be provided to a tenant or to a team based on authentication credentials associated with the tenant or the team.

### CROSS-REFERENCE TO RELATED APPLICATION(S)

This application claims priority to U.S. Provisional Application No. 62/486,431 entitled “Shared Templates in a Collaborative Work Environment,” filed on Apr. 17, 2017, of which the entire disclosure is hereby incorporated by reference in its entirety.

### BACKGROUND

In current work environments, a team of individuals work on a particular task or project collaboratively. Many times, another team may have completed a similar or related task in the past. Unfortunately, the processes, operations, and jobs that the previous team performed are typically not captured or recorded in a meaningful and reusable format. Consequently, the new team cannot benefit from the experiences and knowledge gained by the previous team. For example, a previous team of design engineers that developed a product may have created design schedules, a list of supply vendors, a calendar to assist in tracking the completion of the product design, and one or more communication channels that received data and information related to the product. However, because this information is not available to the new design team, the new design team may have to recreate some or all of the information when designing the new product.

Educational institutions, teachers, tutors, and other educational professions can have a similar problem in that a class typically follows a lesson plan that may not vary much over time. Additionally or alternatively, an educational institution may instruct its teachers to follow a specific class assignment schedule or lesson plan for a class that is offered regularly by the educational institution.

It is with respect to these and other general considerations that embodiments have been described. Also, although relatively specific problems have been discussed, it should be understood that the embodiments should not be limited to solving the specific problems identified in the background.

### SUMMARY

This disclosure generally relates to systems and methods for providing one or more reusable templates to teams working on a particular task or project. A reusable or shared template is a pre-defined data structure that includes one or more elements related to the particular task. The template can assist the team in communicating about the task, working on the task, tracking the progress of the task, and/or completing the task. Teams can be formed within work environments, education environments, social environments, etc. The shared template(s) can be stored on a global repository or on a tenant repository. In aspects, multiple users (e.g., tenants) can access the shared template(s) stored on the global repository while the members of a team associated with the tenant may access the shared template(s) on the tenant repository. A shared template may be provided to a tenant or to a team based on authentication credentials associated with the tenant or the team.

In one aspect, a system includes at least one processing unit and at least one memory. The at least one memory stores computer executable instructions that, when executed by the at least one processing unit, performs a method that includes receiving a selection of a shared template, providing access to the shared template to one or more additional client computing devices, causing the selected shared template to be displayed in response to providing access, and receiving one or more interactions with the selected shared template. The shared template is a pre-defined structure that includes elements associated with an educational task, where the elements include a team panel that includes one or more classes, and an operations panel that comprises an assignment panel including at least one assignment for each class. Each of the one or more client computing devices is associated with a team member that is able to access the selected shared template. For example, each of the team members may be a student enrolled or attending a class.

In another aspect, a method includes selecting a set of available templates from one or more shared templates based on authentication credentials, causing the set of available templates to be displayed, receiving a selection of or selecting a given shared template from the set of available templates, and receiving one or more interactions to the selected shared template. Each of the one or more shared templates in the set of available templates has a pre-defined structure that includes elements associated with an educational task. The elements may include a team panel that includes one or more classes and an operations panel that includes an assignment panel comprising at least one assignment for each class.

In yet another aspect, a server computing device includes at least one processing unit and at least one memory. The at least one memory stores a first set of shared templates in a global repository and a second set of shared templates in a tenant repository. The first set of shared templates is accessible to multiple users and the second set of shared templates is accessible to a tenant. The at least one memory further stores computer executable instructions that, when executed by the at least one processing unit, performs a method. The method includes receiving, over a network, a request for a shared template and selecting a set of available templates from the first set of shared templates or from the second set of shared templates based on authentication credentials included in the request. Each of the shared templates in the first and in the second sets of shared templates includes an assignment section that comprises at least one assignment for a class offered by an educational institution.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following Figures. The elements of the drawings are not necessarily to scale relative to each other. Identical reference numerals have been used, where possible, to designate identical features that are common to the figures.

FIG. 1 illustrates a first example system that includes one or more shared templates;

FIG. 2 depicts one example of a shared template that is suitable for use in the first example system shown in FIG. 1;

FIG. 3 depicts a second example system that includes one or more shared templates;

FIG. 4 depicts one example of a shared template that is suitable for use in the second example system shown in FIG. 3;

FIG. 5 is a flowchart depicting an example method of sharing a template;

FIG. 6 is a flowchart illustrating an example method of selecting a template;

FIG. 7 is a block diagram depicting example physical components of a computing device with which aspects of the disclosure may be practiced;

FIGS. 8A and 8B are simplified block diagrams of a mobile computing device with which aspects of the present disclosure may be practiced; and

FIG. 9 is a simplified block diagram of a distributed computing system in which aspects of the present disclosure may be practiced.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Embodiments may be practiced as methods, systems or devices. Accordingly, embodiments may take the form of a hardware implementation, an entirely software implementation, or an implementation combining software and hardware aspects. The following detailed description is therefore not to be taken in a limiting sense, and the scope of the present disclosure is defined by the appended claims and their equivalents.

This disclosure generally relates to systems and methods that provide one or more shared templates to teams within a tenant. The term “tenant” is to be construed broadly as including a company, an enterprise, an educational institution, a school district, a classroom, an organization, a business, an association, an institution, an ad-hoc group, vendors, third parties, and the like. A tenant can include one or more sub-entities or “teams”, with each team including one or more team members. Generally, the team members on a team work collaboratively on a project, a product, a job, or an assignment (referred to herein as a “task”). The team members on a team can meet and work together virtually and/or in person. In some embodiments, a “tenant” is an educational institution, a tutor, a teacher, a school district, or some other educational organization and a “team” is a class, an assignment, a project, or other educational operation that a team member (e.g., student) is enrolled in, participating in, or attending.

A “shared template” is a pre-defined data structure that can assist the team members in communicating about a task, working on the task, tracking the progress of the task, and/or completing the task. In aspects, a shared template is designed or created for a particular task by any suitable person, including, but not limited to, an information technology (IT) administrator, a team member (e.g., a team leader), an education professional (e.g., teacher), and/or a third party content provider. A shared template may include one or more elements that assist the team members with the task. The element(s) in a shared template can be selected, arranged, and configured in a pre-defined format to provide each team that works on a similar task with a reusable template that the team members can use and, if desired customize for their particular task. In one non-limiting example, the elements in a shared template include one or more channels, applications (e.g., bots, tabs, calendars, spreadsheets, planners, trackers, and the like), documents, conversations, notes, assignments, notebooks, grade books, and/or files.

Each team member may access, edit, comment, post or otherwise interact with a shared template. For example, a team member can add data or information (“content”) to one or more elements in the shared template, delete content from an element or elements, and/or modify content in one or more elements. Additionally or alternatively, a team member can add, delete, and/or modify one or more elements in the shared template. In one non-limiting example, a team member may navigate a directory structure, input content (e.g., a message, a calendar item), or search for specific content, among other actions.

In some embodiments, shared templates can be stored on a tenant repository and/or on a global repository. Only team members associated with a particular tenant may access the shared templates stored on the tenant repository, and in some instances, only the team members associated with a particular task can access particular or select shared templates on the tenant repository. This allows the tenant to store proprietary shared templates on the tenant repository and limit access to those shared templates to team members (or to certain team members) associated with the tenant.

In some implementations, a service provider can store and/or provide access to one or more shared templates. For example, a tenant can work with a service provider such that the service provider creates, stores, and/or provides shared templates to the team members associated with that tenant. Each team member can have an account with the service provider. When a team member accesses his or her account, each shared template associated with that team member can be listed or displayed in the account. In a non-limiting example, a team member named Joe Smith can access his account via the website of Service Provider A. After entering authentication credentials, Joe Smith can view a display of the shared templates assigned to him. In this manner, a tenant can dynamically change the shared templates assigned to a team member. Additionally, the tenant may indicate the team members assigned to a particular shared template prior to the creation of a team and/or in advance of any team members knowing they are assigned to the team. The shared template is then provided to the team members when the team members log into their respective accounts with the service provider. This can eliminate the operation of creating a team after a shared template is selected and/or used.

In some implementations, multiple users (e.g., all tenants and/or team members) can use the shared templates stored on the global repository. A tenant, a service provider, or a third party (e.g., a content provider) may create and store the shared templates on the global repository. In some instances, authentication credentials associated with a user (e.g., a tenant or team member) determine which shared templates on the global repository the user can access. For example, a user may obtain a license to use select templates stored on the global repository. The license agreement allows the shared templates that are accessible to the user to change dynamically based on the terms of the license (e.g., the fees paid by the user and/or the shared templates selected by the user).

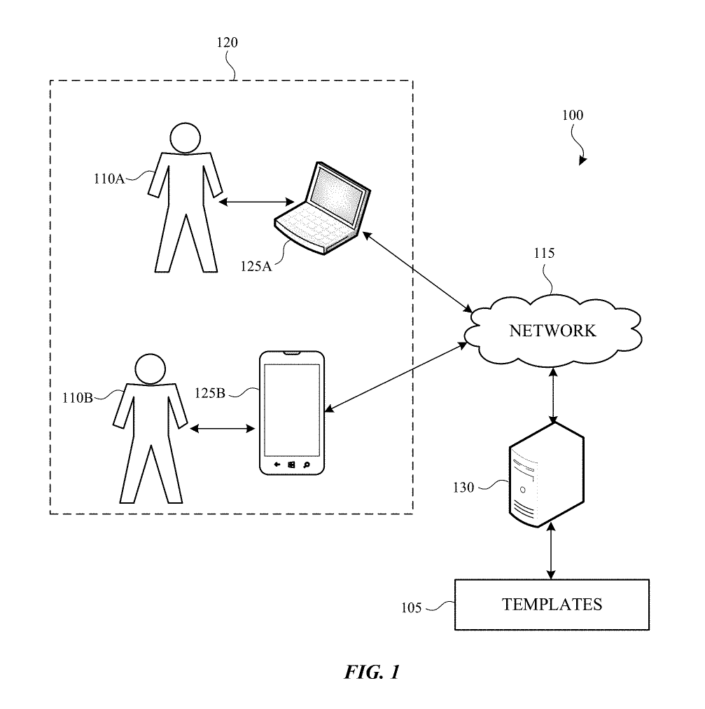

FIG. 1 illustrates a first example system that includes one or more shared templates. The system 100 is a communication system or service that provides one or more shared templates 105 for team members 110A, 110B to use over a network 115. The team members 110A, 110B are associated with an enterprise, company, or a business 120 in the representative embodiment. The team members 110A, 110B may be located at the same physical site or the team members 110A, 110B can be situated at different locations. The network 115 is illustrative of an enterprise-based network, for example, an intranet, and/or a distributed computing network, for example, the Internet, over which the various team members 110A, 110B may communicate with each other and with other computing systems.

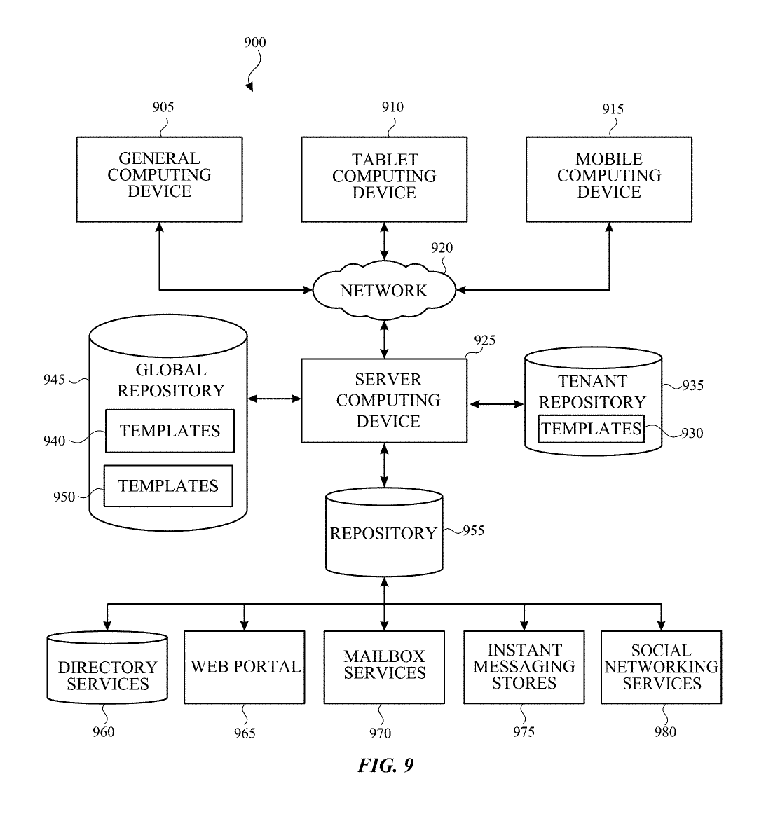

In aspects, a client computing device, such as for example, the client computing device 125A and the client computing device 125B, may access the network 115 and select, retrieve, and use one or more shared templates 105 stored on a server computing device 130. While the team members 110A, 110B are using a selected shared template, the selected shared template can be stored on the server computing device 130 or on another storage repository (e.g., tenant repository 935 in FIG. 9).

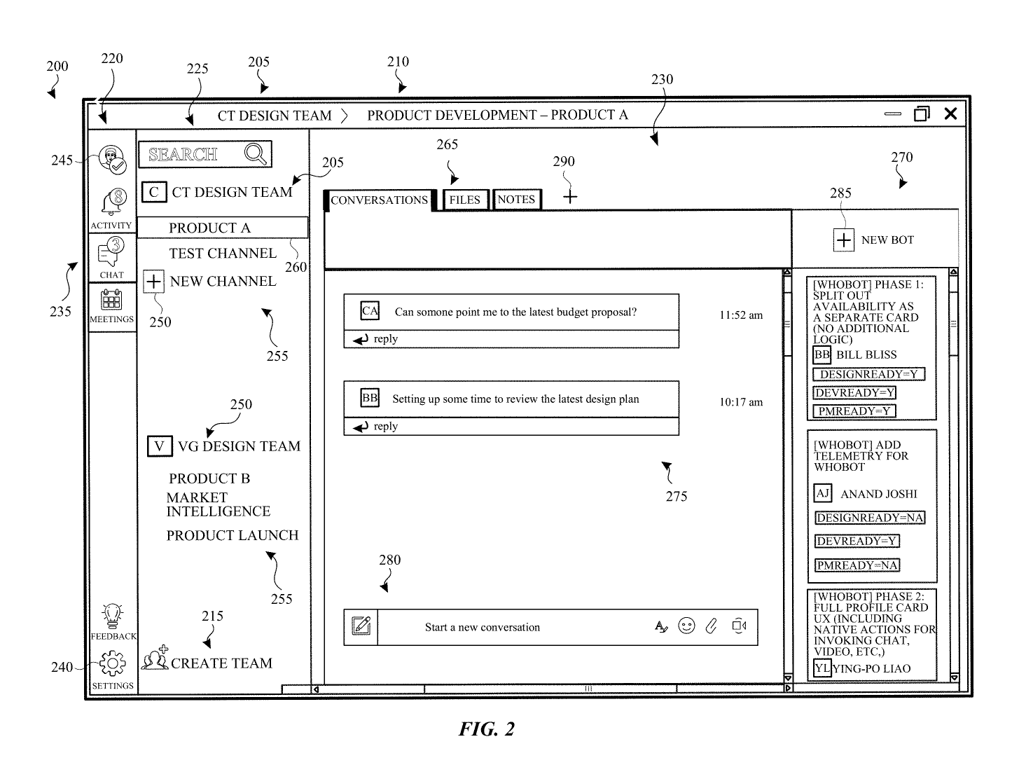

FIG. 2 depicts one example of a shared template that is suitable for use in the first example system shown in FIG. 1. As described earlier, a shared template is a pre-defined structure that can assist team members in communicating about a task, working on the task, tracking the progress of the task, and/or completing the task. A shared template may be designed or created for a particular task by any suitable person, including, but not limited to, an information technology (IT) administrator, a team member (e.g., a team leader), a team supervisor, and/or a third party (e.g., service and/or content provider). The shared template may include one or more elements such as one or more channels, applications (e.g., bots, tabs, calendars, spreadsheets, planners, trackers, and the like), documents, connectors, conversations, notes, files, and other elements that may assist the team members with the task. The elements in a shared template can be selected, arranged, and/or configured in a pre-defined format to provide a team working on a particular task with a reusable template that the team members can use and if desired, customize for their particular task.

In the illustrated embodiment, the shared template 200 can include identification information for a team 205 and the task 210 associated with the template 200. In FIG. 2, the identified team 205 is the team having an element that a team member 245 is currently accessing or interacting with (e.g., channel 260).

The representative template 200 may also include a “create team” operation 215 that allows a suitable person (e.g., an IT administrator or a team leader) to create a team and/or add a team member. In one embodiment, the create team operation 215 associates authentication credentials for each team member (e.g., an email address, user name, user name and password, etc.) with the shared template 200 that allows the team member to access and use the shared template 200.

In some embodiments, the elements in the shared template 200 can be arranged in different displays or panels. For example, the illustrative shared template 200 includes an application panel 220, a team panel 225, and an operations panel 230. In one embodiment, the elements in the application panel 220, the team panel 225, and the operations panel 230 are selected or pre-pinned to the shared template 200 when the shared template 200 is created.

The application panel 220 includes one or more applications 235 (e.g., calendar, chat, activities) and other elements that assist the team members with the task. A team member can add an application using the “settings” operation 240 (or some other suitable operation).

When a team member 245 is accessing the shared template 200, each team the team member 245 is associated with can be listed in the team panel 225. For example, in the shared template 200, the team member 245 is assigned to two teams; the CT Design Team 205 and the VG Design Team 250. Each team 205, 250 includes one or more channels 255. In one non-limiting example, a channel 255 is communication channel that includes one or more communication elements. In the illustrated embodiment, the channel “Product A” 260 is selected, which causes the operations panel 230 to display a tabs panel 265 and a bots panel 270 that are associated with the Product A channel 260. As shown in FIG. 2, three tabs (conversations, files, notes) are included in the tabs panel 265, with the selected conversations tab including two conversational posts 275 and a “start a new conversation” operation 280.

Three bots are depicted in the bots panel 270. In aspects, each bot is an application that runs automated tasks or scripts, usually over a network (e.g., intranet or Internet). The bots perform one or more operations and/or provide information that relate to the task (e.g., development of Product A).

Each team member may access, read, edit (add, modify, and/or delete content in an element and/or add, modify or delete an element), comment, post or otherwise interact with the shared template 200. For example, a team member can add a bot using the “new bot” operation 285 and add a tab using the new tab “+” operation 290. In some embodiments, a team member can add one or more elements not shown in FIG. 2.

Although the shared template 200 is depicted with two teams 205, 250, three channels 255, five applications 235, three tabs, three bots, other embodiments are not limited to this configuration. A shared template can include any number of teams, channels, applications, tabs, and/or bots in other embodiments. Additionally, a shared template can include additional or fewer elements in other embodiments. For example, a shared template may omit the bots panel 270. Similarly, a shared template can include an element not shown in FIG. 2.

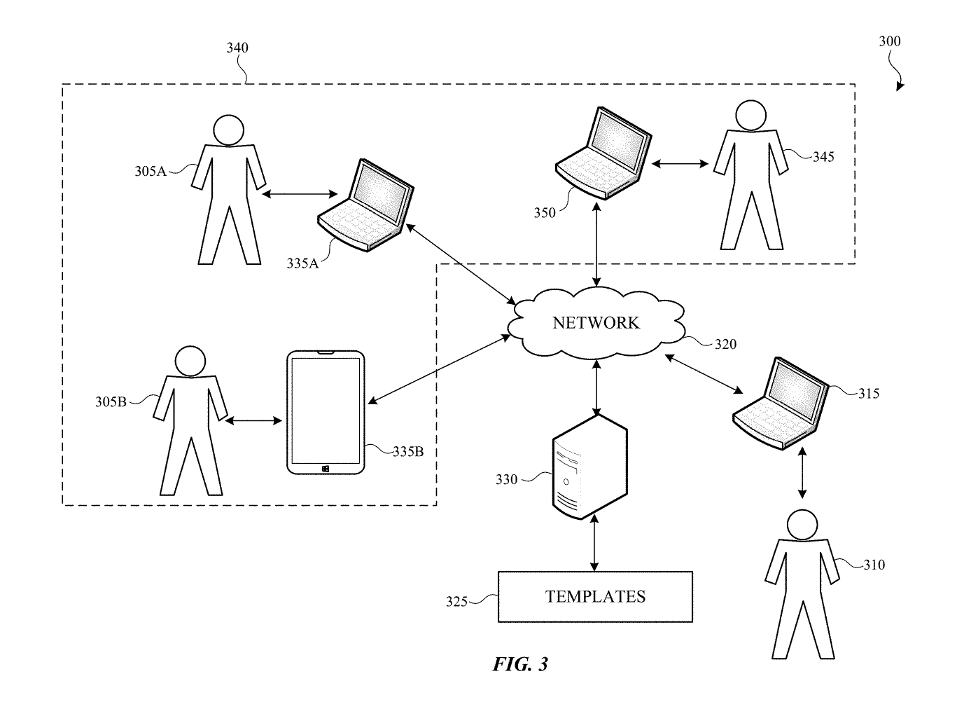

FIG. 3 depicts a second example system that includes one or more shared templates. In the representative embodiment, the system 300 is associated with an educational institution and the team members 305A, 305B are students. A suitable person (e.g., a IT administrator, a school district administrator, a teacher) 310 can use a client computing device 315 to access a network 320 and create and/or store one or more shared templates 325 on the server computing device 330.

The shared template(s) 325 can each be associated with an educational “task” (e.g., a class, a lesson, an assignment, a project) that the team members 305A, 305B (e.g., students) may access and interact with over the network 320. The client computing devices 335A, 335B may access the network 320 and select, retrieve, and use one or more shared templates 325 stored on the server computing device 330. While the team members 305A, 305B are using a selected shared template, the selected shared template can be stored on the server computing device 330 or on another storage repository.

Like the embodiment shown in FIG. 1, the network 320 is illustrative of an intranet and/or a distributed computing network, for example, the Internet, over which the various team members (e.g., students, teachers) may communicate with each other and with other computing systems.

The system 300 allows a “classroom” 340 to be created by providing an educational task for the team members 305A, 305B (e.g., students). Moreover, the system 300 permits the formation of multiple classrooms that may include the same team members or different team members. The classroom 340 can be an actual (physical) classroom or a virtual classroom. While the team members 305A, 305B work on the task associated with a particular shared template, a suitable person 345 such as a teacher, a tutor, or an assistant can access the shared template, monitor the progress of the team members 305A, 305B, and/or grade the completed task or individual sub-tasks that collectively form the task (via the client computing device 350).

In some embodiments, each client computing device 125A, 125B, 335A, 335B, 350 is a personal or handheld computing device having both input elements and output elements. For example, the client computing device 125A, 125B, 315 335A, 335B, 350 may be one of: a mobile telephone; a smart phone; a tablet; a phablet; a smart watch; a wearable computer; a personal computer; a desktop computer; a laptop computer; a gaming device/computer (e.g., Xbox); a television; and the like. This list is for illustrative purposes only and should not be considered as limiting. Any suitable client computing device that is suitable for creating, receiving, revising, and/or interacting with a shared template can be utilized.

In some instances, each shared template can provide pre-defined elements that multiple team members may access, use (e.g., add content to the elements within the shared template), and/or customize (e.g., modify the elements within a shared template). The content may be provided by various services—both local services (e.g., services, applications and products provided or otherwise hosted by the server computing device 130 or 330) and external or third party services. Example services include, but are not limited to, word processing applications or services, spreadsheet applications or services, line-of-business (LOB) management services, customer relationship management (CRM) services, debugging services, accounting services, payroll services and so on. In other examples, the content associated with a shared template may include content from websites and/or applications, such as social media or networking websites, photo sharing websites, video and music streaming websites, messaging applications, search engine websites, sports, news or entertainment websites, and the like.

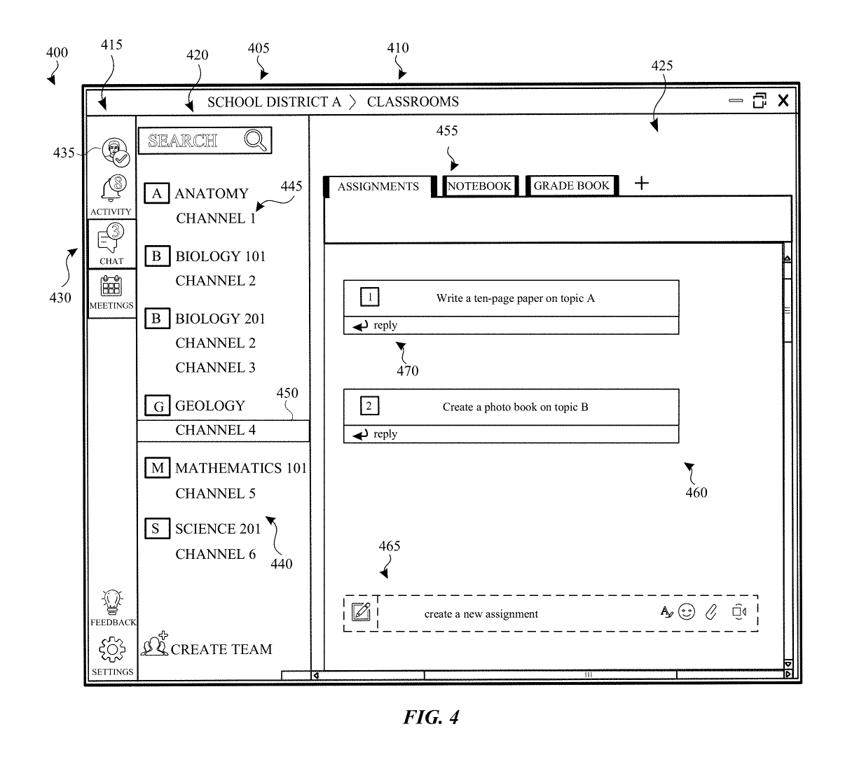

FIG. 4 depicts one example of a shared template that is suitable for use in the second example system shown in FIG. 3. As described earlier, the elements in the shared template 400 are selected for one or more educational tasks. In the illustrated embodiment, the tenant is a school district or educational institution and the teams are classes offered at the school district. The elements in the shared template 400 are selected, arranged, and/or configured in a pre-defined format to provide each team with a reusable template that the team members (e.g., students) can interact with while attending the class.

The shared template 400 may include identification information for the tenant 405 (e.g., school district A) and the tasks 410 associated with the tenant 405. In some embodiments, the shared template 400 arranges the elements in different displays or panels. For example, the shared template 400 includes an application panel 415, a team panel 420, and an operations panel 425. In one embodiment, the elements in the application panel 415, the team panel 420, and the operations panel 425 are selected or pre-pinned to the shared template 400 when the shared template 400 is created. For example, the application panel 415 includes one or more applications 430 (e.g., calendar, chat, activities) and other elements that assist the team members with the task.

When a team member 435 accesses the shared template 400, each team the team member 435 is associated with is listed in the team panel 415. For example, in the shared template 400, the team member 435 is assigned to six teams (e.g., classes) 440; anatomy, biology 101, biology 201, geology, mathematics 101, and science 201. Each team 440 includes one or more channels 445. In the illustrated embodiment, “channel 4” 450 is selected, which causes the operations panel 425 to display the tabs panel 455 associated with that channel 450. As shown in FIG. 4, three tabs (assignments, notebook, grade book) are included in the tabs panel 455, with the selected assignments tab displaying two assignments 460 and a “Create a new assignment” operation 465.

In some embodiments, certain elements may not be displayed or accessed by all of the team members. For example, the “create a new assignment” operation 465 may be disabled (represented by the dashed line) when a team member (e.g., a student) is interacting with the shared template 400, but enabled when a teacher is accessing the shared template 400. Thus, student team members can access the shared template 400 to receive assignments, keep notes and ask questions, and/or view grades, while teacher team members may access the shared template 400 to create or review assignments, answer questions in the notebook tab, and/or assign a grade to an assignment.

Although the shared template 400 is depicted with six teams 440, a select number of channels 445, five applications 235, and three tabs, other embodiments are not limited to this configuration. A shared template can include any number of teams, channels, applications, and/or tabs in other embodiments. Additionally, a shared template can include additional or fewer elements in other embodiments. For example, a shared template may include a bots panel. Similarly, a shared template can include an element not shown in FIGS. 2 and 4.

In one non-limiting example, the assignments tab in the channel 4 450 lists two assignments. The first assignment is to write a ten-page paper on topic A and the second assignment is the creation a photo book on topic B. The team member 435 accesses the shared template 400 to obtain the two assignments. While working on the first assignment, the team member 435 can keep notes, ask the teacher questions, review the teacher's answers through the notebook tab, and submit the completed ten-page paper using the “reply” operation 470 associated with the first assignment. Additionally or alternatively, the team member 435 may be able to ask questions to other team members in the Geology team using the notebook tab. The teacher can provide a grade for the first assignment in the grade book tab, and the team member 435 may see the grade by opening the grade book tab.

Thus, a shared template can be created for a particular task. The particular task may be assigned to, or associated with one team or multiple teams. When created, the shared template includes one or more elements that are pre-pinned to the shared template. The one or more elements can be common to each team, or the element(s) may vary by team. For example, in FIG. 4, the element channel 1 is associated with the team “Anatomy”, the element channel 2 is associated with the team “Biology 101”, and the elements channel 2 and channel 3 are assigned to the team “Biology 201.” Similarly, the tabs panel and/or the bots panel can include elements that are pre-pinned to those panels, and those elements may be common across the teams or may vary based on the team.

The creator of the shared template can select the pre-pinned elements in a shared template based on the type of elements that have been used in the past to complete similar tasks. In some embodiments, a team member can modify the elements in the shared template by deleting a pre-pinned element and/or by adding a new element. In this manner, the team members can customize a shared template.

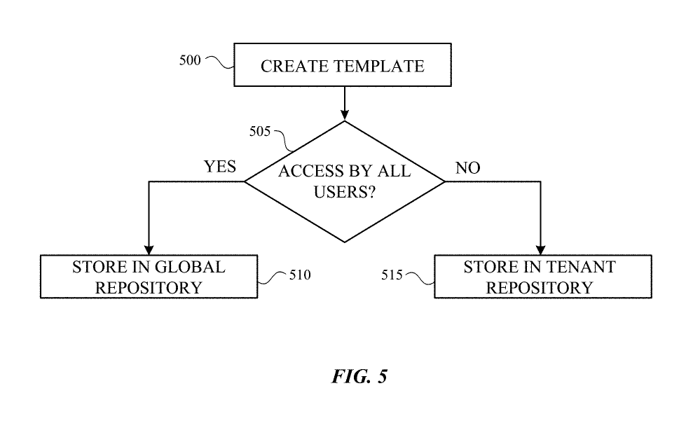

FIG. 5 is a flowchart illustrating an example method of sharing a template. Initially, a shared template is created at block 500. Any suitable person or entity may create a template. For example, a tenant (e.g., a team member or an information technology (IT) administrator associated with the tenant) and/or a third party (e.g., a content provider) can create a shared template.

A determination is then made at block 505 as to whether or not the shared template will be accessible to multiple users (e.g., all tenants and all team members). If so, the process passes to block 510 where the shared template is stored in a global repository. If the shared template will be accessible to a limited number of users (e.g., to the team members associated with a particular tenant), the method continues at block 515 where the shared template is stored in a tenant repository.

In one example, an IT administrator employed by a tenant (e.g., a company) can create shared templates for one or more departments within the tenant. For example, the IT administrator may create one or more shared templates for the accounting department (e.g., an accounting team), the sales department (e.g., a sales team) and each product development team in the engineering department (product development teams). The IT administrator can assign credentials to a shared template that allows only the team members associated with that team to access the shared template. Alternatively, the IT administrator can assign credentials to a shared template that allows the team members associated with all of the teams to access the shared template. The IT administrator can then store the shared templates on a repository associated with the tenant (e.g., a tenant repository). The tenant repository can be accessed via an intranet (e.g., a local storage repository) or via the Internet (e.g., a cloud storage repository).

In another example, a third party content provider may create shared templates that are accessible to all users via a license agreement. For example, the third party content provider can produce shared templates for different accounting processes and a tenant can obtain a license that allows the tenant to access all of the shared templates or select shared templates.

Additionally or alternatively, a tenant may purchase all or select shared templates from a third party content provider. For example, the third party content provider may sell shared templates to users (e.g., tenants) via a website and/or a subscription service. In some embodiments, one or more shared templates may be distributed with a software application.

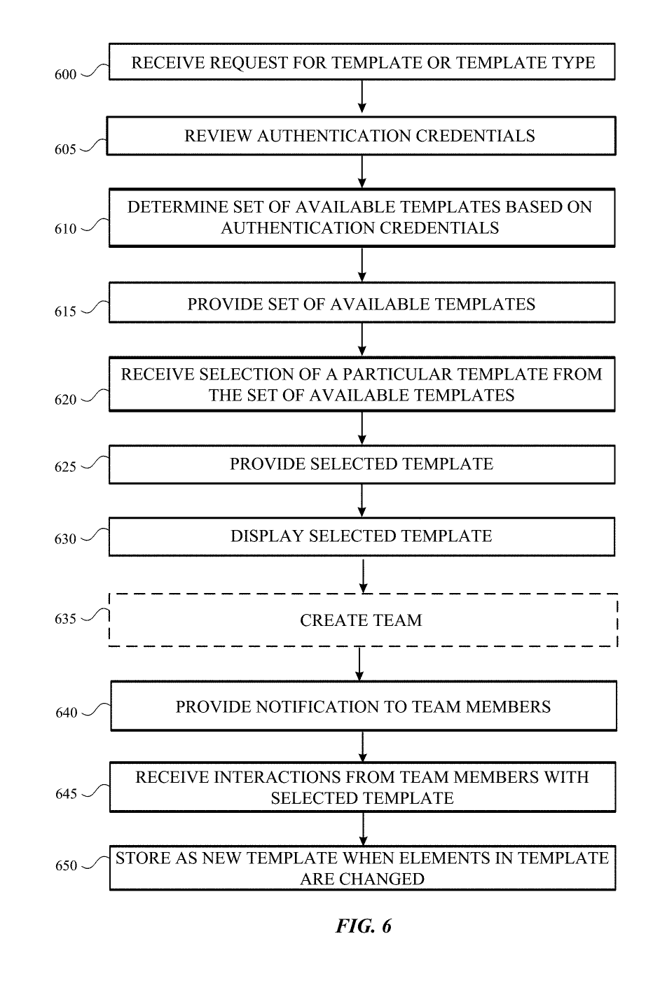

FIG. 6 is a flowchart depicting an example method of selecting a template. Initially, as shown in block 600, a request for a shared template (or for a shared template type) is received from a team member or a tenant (a “requestor”). In some embodiments, the shared templates can be grouped by shared template type. The “type” for a shared template can be associated with a task, a tenant, or any other suitable classification type. For example, a request for a shared template type can produce one or more shared templates associated with the task of product development. Additionally or alternatively, a request for a shared template type can return one or more shared templates associated with a particular tenant, such as an educational institution.

The request may be received by a server computing device (e.g., server computing device 130 in FIG. 1) that stores shared templates. In response to the request, authentication credentials associated with the request (e.g., with the requestor) are reviewed at block 605, and a set of available templates (or a list of the templates in the set of available templates) is determined or selected at block 610 based on the authentication credentials. The review of the authentication credentials and the selection of the set of available templates can be performed by a client computing device (e.g., client computing device 125A in FIG. 1) or the server computing device that stores the shared templates. The set of available templates can include one or more shared templates. The shared template(s) in the set of available templates is also based on the shared template or the shared template type that was included in the request.

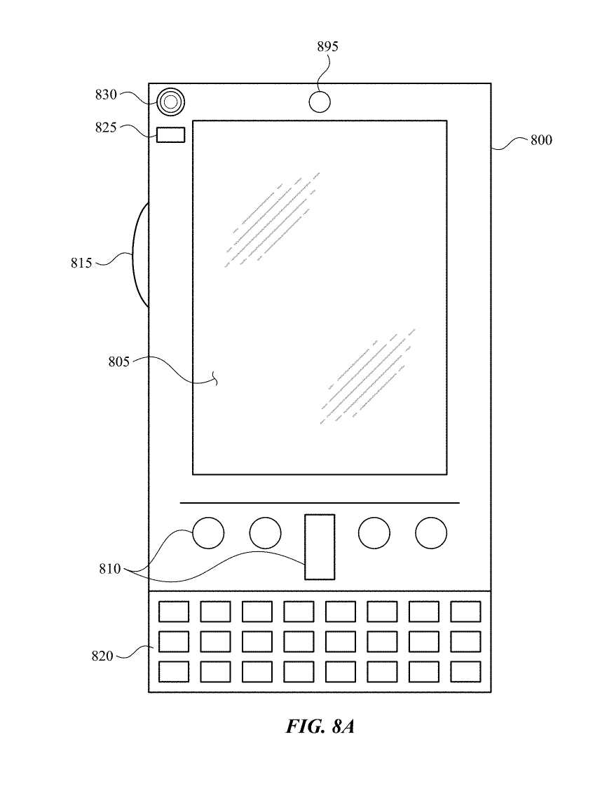

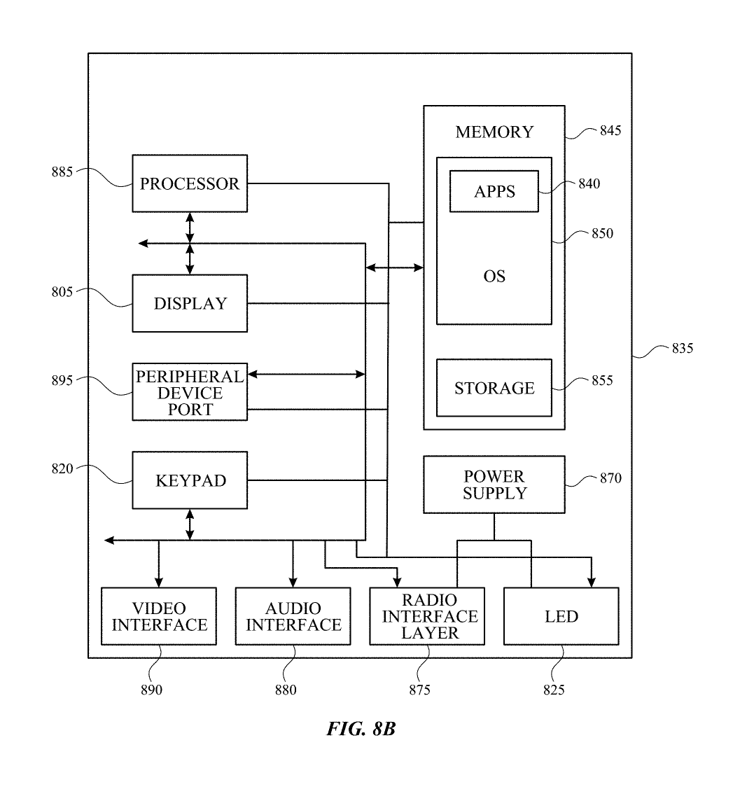

Next, as shown in block 615, the set of available templates, or a representation of the set of available templates (e.g., a list), is provided to the requestor. In one embodiment, the set of available templates is displayed on a client computing device (e.g., display 805 in FIG. 8A). The requestor may then select a particular shared template from the set of available templates (block 620). Next, at block 625, access to the selected shared template is provided to the requestor. Responsive to providing access to the selected shared template, the selected shared template may be displayed on a client computing device associated with the requestor (block 630).

In some embodiments, the requestor may create a team (e.g., the create team operation 215 in FIG. 2) at block 635. A notification may be provided to each team member on the team after the team is created (block 640). In one non-limiting example, an email, instant message, or text can be sent to each team member. The notification may provide access information such as a link, an address, or other suitable access information to each team member that permits the team member to access and/or interact with the selected shared template. In some embodiments, the team forms a classroom, the team members include students and the task is an educational task. In other embodiments, the team, the team members, and the task are associated with a tenant such as a business, a company, or an enterprise.

Block 635 is optional and may be omitted in other embodiments. Instead of creating a team after a shared template is selected, the team may be created when the shared template is created. Additionally or alternatively, a suitable person (e.g., IT administrator, teacher) may assign team members to a team prior to the initiation of a task. For example, a teacher may assign students to a class in a shared template before the start date of the class.

Additionally or alternatively, block 640 is optional and can be omitted in other embodiments. A team member may be provided with access to a shared template based on his or her authentication credentials (e.g., email address, user name, user name and password, etc.). For example, one or more shared templates associated with a team member can be listed in the team member's account or in an application program (e.g., email application, group-based communication application) when the team member logs into the application program or account.

One or more team members then interact with the selected shared template (block 645). The selected shared template can be stored on the server computing device (e.g., in a tenant repository) or on a different computing device while the team uses the selected shared template to work on or complete the task.

The selected shared template can be saved as a new shared template if the team customizes or adapts the selected shared template by adding, changing, or deleting one or more elements in the shared template (block 650). In one embodiment, the new shared template is saved using the process depicted in FIG. 5.

As should be appreciated, FIG. 6 is described for purposes of illustrating the present methods and systems and is not intended to limit the disclosure to a particular sequence of steps or a particular combination of hardware or software components.

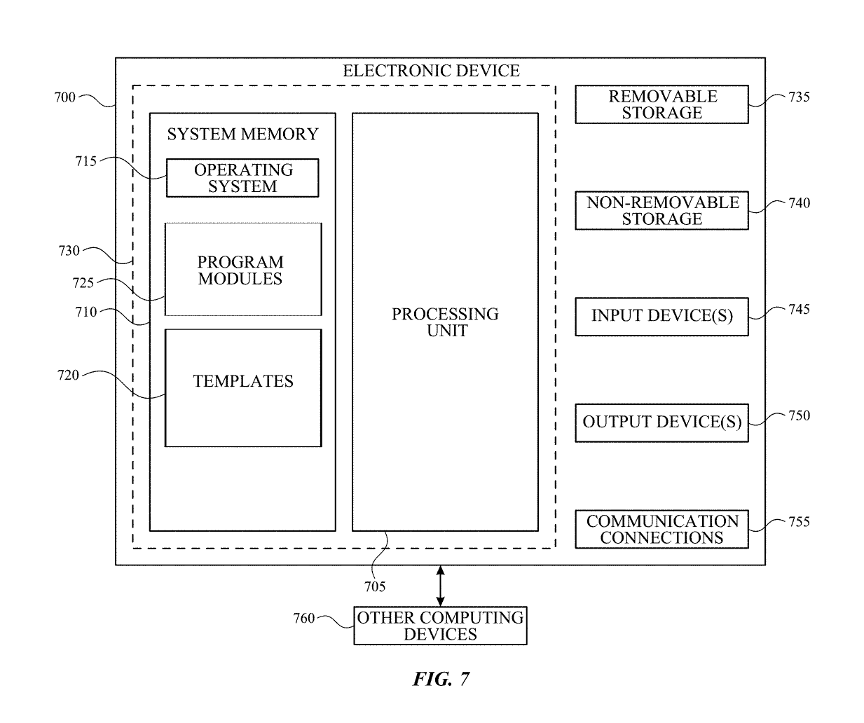

FIGS. 7-9 and the associated descriptions provide a discussion of a variety of operating environments in which aspects of the disclosure may be practiced. However, the devices and systems illustrated and discussed with respect to FIGS. 7-9 are for purposes of example and illustration and are not limiting of a vast number of electronic device configurations that may be utilized for practicing aspects of the disclosure, as described herein.

FIG. 7 is a block diagram illustrating physical components (e.g., hardware) of an electronic device 700 with which aspects of the disclosure may be practiced. The computing device components described below may be suitable for the computing devices described above, including the client computing devices 125A, 125B, 350, 335A, 335B and the server computing device 130, 330.

In a basic configuration, the electronic device 700 may include at least one processing unit 705 and a system memory 710. Depending on the configuration and type of the electronic device, the system memory 710 may comprise, but is not limited to, volatile storage (e.g., random access memory), non-volatile storage (e.g., read-only memory), flash memory, or any combination of such memories. The system memory 710 may include a number of program modules and data files, such as an operating system 715, one or more shared templates 720, and one or more program modules 725 suitable for parsing received input, determining subject matter of received input, determining actions associated with the input and so on. While executing on the processing unit 705, the program modules 725 may perform processes including, but not limited to, the aspects, as described herein.

The operating system 715, for example, may be suitable for controlling the operation of the electronic device 700. Furthermore, embodiments of the disclosure may be practiced in conjunction with a graphics library, other operating systems, or any other application program and is not limited to any particular application or system. This basic configuration is illustrated in FIG. 7 by those components within a dashed line 730.

The electronic device 700 may have additional features or functionality. For example, the electronic device 700 may also include additional data storage devices (removable and/or non-removable) such as, for example, magnetic disks, optical disks, or tape. Such additional storage is illustrated in FIG. 7 by a removable storage device 735 and a non-removable storage device 740.

The electronic device 700 may also have one or more input device(s) 745 such as a keyboard, a trackpad, a mouse, a pen, a sound or voice input device, a touch, force and/or swipe input device, etc. The output device(s) 750 such as a display, speakers, a printer, etc. may also be included. The aforementioned devices are examples and others may be used. The electronic device 700 may include one or more communication connections 755 allowing communications with other electronic devices 760. Examples of suitable communication connections 755 include, but are not limited to, radio frequency (RF) transmitter, receiver, and/or transceiver circuitry; universal serial bus (USB), parallel, and/or serial ports.

The term computer-readable media as used herein may include computer storage media. Computer storage media may include volatile and nonvolatile, removable and non-removable media implemented in any method or technology for storage of information, such as computer readable instructions, data structures, or program modules.

The system memory 710, the removable storage device 735, and the non-removable storage device 740 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the electronic device 700. Any such computer storage media may be part of the electronic device 700. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. For example, embodiments of the disclosure may be practiced via a system-on-a-chip (SOC) where each or many of the components illustrated in FIG. 7 may be integrated onto a single integrated circuit. Such an SOC device may include one or more processing units, graphics units, communications units, system virtualization units and various application functionality all of which are integrated (or “burned”) onto the chip substrate as a single integrated circuit.

When operating via an SOC, the functionality, described herein, with respect to the capability of client to switch protocols may be operated via application-specific logic integrated with other components of the electronic device 700 on the single integrated circuit (chip). Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

FIGS. 8A and 8B illustrate a mobile electronic device 800, for example, a mobile telephone, a smart phone, wearable computer (such as a smart watch), a tablet computer, a laptop computer, and the like, with which embodiments of the disclosure may be practiced. With reference to FIG. 8A, one aspect of a mobile electronic device 800 for implementing the aspects is illustrated.

In a basic configuration, the mobile electronic device 800 is a handheld computer having both input elements and output elements. The mobile electronic device 800 typically includes a display 805 and one or more input buttons 810 that allow the user to enter information into the mobile electronic device 800. The display 805 of the mobile electronic device 800 may also function as an input device (e.g., a display that accepts touch and/or force input).

If included, an optional side input element 815 allows further user input. The side input element 815 may be a rotary switch, a button, or any other type of manual input element. In alternative aspects, mobile electronic device 800 may incorporate more or less input elements. For example, the display 805 may not be a touch screen in some embodiments. In yet another alternative embodiment, the mobile electronic device 800 is a portable phone system, such as a cellular phone. The mobile electronic device 800 may also include an optional keypad 820. Optional keypad 820 may be a physical keypad or a “soft” keypad generated on the touch screen display.

In various embodiments, the output elements include the display 805 for showing a graphical user interface (GUI) and a set of available templates, a visual indicator 825 (e.g., a light emitting diode), and/or an audio transducer 830 (e.g., a speaker). In some aspects, the mobile electronic device 800 incorporates a vibration transducer for providing the user with tactile feedback. In yet another aspect, the mobile electronic device 800 incorporates input and/or output ports, such as an audio input (e.g., a microphone jack), an audio output (e.g., a headphone jack), and a video output (e.g., a HDMI port) for sending signals to or receiving signals from an external device.

FIG. 8B is a block diagram illustrating the architecture of one aspect of a mobile electronic device 800. That is, the mobile electronic device 800 can incorporate a system (e.g., an architecture) 835 to implement some aspects. In one embodiment, the system 835 is implemented as a “smart phone” capable of running one or more applications (e.g., browser, e-mail, calendaring, contact managers, messaging clients, games, media clients/players, content selection and sharing applications and so on). In some aspects, the system 835 is integrated as an electronic device, such as an integrated personal digital assistant (PDA) and wireless phone.

One or more application programs 840 may be loaded into the memory 845 and run on or in association with the operating system 850. Examples of the application programs include phone dialer programs, e-mail programs, personal information management (PIM) programs, word processing programs, spreadsheet programs, Internet browser programs, messaging programs, and so forth.

The system 835 also includes a non-volatile storage area 855 within the memory 845. The non-volatile storage area 855 may be used to store persistent information that should not be lost if the system 835 is powered down.

The application programs 840 may use and store information in the non-volatile storage area 855, such as email or other messages used by an email application, and the like. A synchronization application (not shown) also resides on the system 835 and is programmed to interact with a corresponding synchronization application resident on a host computer to keep the information stored in the non-volatile storage area 855 synchronized with corresponding information stored at the host computer.

The system 835 has a power supply 870, which may be implemented as one or more batteries. The power supply 870 may further include an external power source, such as an AC adapter or a powered docking cradle that supplements or recharges the batteries.

The system 835 may also include a radio interface layer 875 that performs the function of transmitting and receiving radio frequency communications. The radio interface layer 875 facilitates wireless connectivity between the system 835 and the “outside world,” via a communications carrier or service provider. Transmissions to and from the radio interface layer 875 are conducted under control of the operating system 850. In other words, communications received by the radio interface layer 875 may be disseminated to the application programs 840 via the operating system 850, and vice versa.

The visual indicator 825 may be used to provide visual notifications, and/or an audio interface 880 may be used for producing audible notifications via an audio transducer (e.g., audio transducer 830 illustrated in FIG. 8A). In the illustrated embodiment, the visual indicator 825 is a light emitting diode (LED) and the audio transducer 830 may be a speaker. These devices may be directly coupled to the power supply 870 so that when activated, they remain on for a duration dictated by the notification mechanism even though the processor 885 and other components might shut down for conserving battery power. The LED may be programmed to remain on indefinitely until the user takes action to indicate the powered-on status of the device.

The audio interface 880 is used to provide audible signals to and receive audible signals from the user (e.g., voice input such as described above). For example, in addition to being coupled to the audio transducer 830, the audio interface 880 may also be coupled to a microphone to receive audible input, such as to facilitate a telephone conversation. In accordance with embodiments of the present disclosure, the microphone may also serve as an audio sensor to facilitate control of notifications, as will be described below.

The system 835 may further include a video interface 890 that enables an operation of peripheral device 895 (e.g., on-board camera) to record still images, video stream, and the like. The captured images may be provided to the artificial intelligence entity advertisement system such as described above.

A mobile electronic device 800 implementing the system 835 may have additional features or functionality. For example, the mobile electronic device 800 may also include additional data storage devices (removable and/or non-removable) such as, magnetic disks, optical disks, or tape. Such additional storage is illustrated in FIG. 8B by the non-volatile storage area 855.

Data/information generated or captured by the mobile electronic device 800 and stored via the system 835 may be stored locally on the mobile electronic device 800, as described above, or the data may be stored on any number of storage media that may be accessed by the device via the radio interface layer 875 or via a wired connection between the mobile electronic device 800 and a separate electronic device associated with the mobile electronic device 800, for example, a server computing device in a distributed computing network, such as the Internet (e.g., server computing device 130 in FIG. 1). As should be appreciated such data/information may be accessed via the mobile electronic device 800 via the radio interface layer 875 or via a distributed computing network. Similarly, such data/information may be readily transferred between electronic devices for storage and use according to well-known data/information transfer and storage means, including electronic mail and collaborative data/information sharing systems.

As should be appreciated, FIG. 8A and FIG. 8B are described for purposes of illustrating the present methods and systems and is not intended to limit the disclosure to a particular sequence of steps or a particular combination of hardware or software components.

FIG. 9 is a simplified block diagram of a distributed computing system in which aspects of the present disclosure may be practiced. The system 900 may include a general computing device 905 (e.g., personal computer), tablet computing device 910, or mobile computing device 915, as described above. The general computing device 905, the tablet computing device 910, and/or the mobile computing device 915 may access one or more networks (represented by network 920) to retrieve, select, interact with, and/or store one or more shared templates stored on one or more server computing devices (represented by server computing device 925). As described earlier, the network 920 is illustrative of an enterprise-based network, for example, an intranet, and/or a distributed computing network, for example, the Internet.

In some embodiments, one or more shared templates 930 can be stored on a tenant repository 935. The tenant repository 935 may be a local storage repository that is accessible only by the tenant (or the team members associated with the tenant) through an intranet or through the Internet. As described earlier, each team may be associated with authentication credentials that define which of the shared template(s) 930 the team (or team members) may access.

Additionally or alternatively, one or more shared templates 940 may be stored on a global repository 945. The global repository 945 may be a cloud storage repository that is accessible through a distributed network, such as the Internet. The shared template(s) 940 may be accessible by all users (e.g., all tenants). As described earlier, each tenant may be associated with authentication credentials that define which of the shared template(s) 940 the user may access. In some aspects, the global repository 945 may also store one or more shared templates 950 that are accessible only by a particular tenant. Access to the shared template(s) 950 can be based on authentication credentials provided by the tenant or by a third party.

In some aspects, the shared templates 930, 940, 950 and/or the general computing device 905, the tablet computing device 910, and/or the mobile computing device 915 may receive (via the server computing device 925) various types of information, data or content (“content”) that is stored by the repository 955. Additionally or alternatively, the shared templates 930, 940, 950 and/or the general computing device 905, the tablet computing device 910, and/or the mobile computing device 915 can receive various types of information or content that is transmitted from a directory service 960, a web portal 965, mailbox services 970, instant messaging stores 975, or social networking services 980. The content can populate one or more elements within a shared template. For example, with reference to the example shared template of FIG. 2, content can be added to the “chat” or “meetings” applications 245, or one or more of the bots in the bots panel 270 may receive and/or process content for the shared template 200.

By way of example, the aspects described above may be embodied in a general electronic device 905 (e.g., personal computer), a tablet electronic device 910 a mobile electronic device 915 (e.g., a smart phone), and/or a server computing device 925. Any of these embodiments of the electronic devices may obtain content from the repository 955 or provide data to the tenant and/or global repositories 935, 945.

As should be appreciated, FIG. 9 is described for purposes of illustrating the present methods and systems and is not intended to limit the disclosure to a particular sequence of steps or a particular combination of hardware or software components.

Although the shared templates are described herein as being created by a team member, an IT administrator, or other suitable individual, other embodiments are not limited to this implementation. In some embodiments, one or more shared templates may be created through the use of application programming interface (API) commands or with automated scripts or programs. In one non-limiting example, these alternate techniques for creating a shared template can create a team, add or delete channels, connectors, bots, and/or tabs.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

1. A system, comprising:
at least one processing unit; and
at least one memory storing computer executable instructions which, when executed by the at least one processing unit, performs a method, comprising:
receiving a selection of a shared template, the shared template comprising a pre-defined structure that includes elements associated with an educational task, the elements comprising:
a team panel that includes one or more classes; and
an operations panel that includes an assignment panel that includes at least one assignment for each class;
providing access to the shared template to one or more client computing devices, wherein each of the one or more client computing devices is associated with a team member that is able to access the selected shared template;
causing the selected shared template to be displayed in response to providing access to the shared template; and
receiving one or more interactions with the selected shared template.

2. The system of claim 1, further comprising instructions for:
receiving, from a client computing device over a network, a request for a shared template type comprising the educational task; and
determining a set of available templates based on the request for the shared template type and on authentication credentials associated with the client computing device.

3. The system of claim 2, wherein the authentication credentials are included in the request for the shared template type.

4. The system of claim 1, wherein each team member is associated with a tenant and the method further comprises instructions for:
receiving, from a client computing device over a network, a request for a shared template type that comprises an identification of the tenant; and
determining a set of available templates is based on authentication credentials associated with the client computing device and on the shared template type.

5. The system of claim 4, wherein the authentication credentials are included in the request for the shared template type.

6. The system of claim 1, wherein the elements further comprise at least one of a channel or a bot.

7. The system of claim 1, wherein the operation of receiving one or more interactions with the selected shared template comprises receiving content for at least one element in the selected shared template.

8. The system of claim 1, wherein the operation of receiving one or more interactions with the selected shared template comprises at least one of:
adding at least one element to the selected shared template; or
deleting at least one element from the selected shared template.

9. The system of claim 1, wherein each team member comprises a student.

10. A method, comprising:
selecting, based on authentication credentials, a set of available templates from one or more shared templates, wherein each of the one or more shared templates has a pre-defined structure comprising one or more elements that are associated with an educational task;
causing the set of available templates to be displayed;
receiving a selection of a shared template from the set of available templates, wherein the one or more elements in the selected shared template comprise:
a team panel that includes one or more classes; and
an operations panel that includes an assignment panel that includes at least one assignment for each class; and
receiving one or more interactions to the selected shared template.

11. The method of claim 10, wherein the operation of selecting, based on authentication credentials, the set of available templates from one or more shared templates comprises selecting, by a client computing device, the set of available templates from the one or more shared templates stored on a server computing device.

12. The method of claim 10, wherein the operation of selecting the set of available templates is based on the authentication credentials and on a shared template type that comprises the particular task.

13. The method of claim 10, wherein each team member is associated with a tenant and the operation of selecting the set of available templates is based on the authentication credentials and on a shared template type that comprises an identification of the tenant.

14. The method of claim 10, further comprising storing the selected shared template as a new shared template on a global repository when an element:
is added to the selected shared template; or
is deleted from the selected shared template.

15. The method of claim 10, further comprising storing the selected shared template as a new shared template on a tenant repository when an element:
is added to the selected shared template; or
is deleted from the selected shared template.

16. A server computing device, comprising:
at least one processing unit; and
at least one memory storing:
a first set of shared templates in a global repository, wherein the first set of shared templates is accessible to multiple users and each shared template in the first set of shared templates;
a second set of shared templates in a tenant repository, wherein the second set of shared templates is accessible to a tenant; and
computer executable instructions which, when executed by the at least one processing unit, performs a method, comprising:
receiving, over a network, a request for a shared template type; and
selecting a set of available templates from the first set of shared templates or from the second set of shared templates based on authentication credentials included in the request, wherein each of the shared templates in the first and in the second sets of shared templates has a pre-defined structure that is associated with an educational task, the pre-defined structure including an assignment section comprising at least one assignment for a class offered by an educational institution.

17. The server computing device of claim 16, wherein the tenant repository is included in the global repository.

18. The server computing device of claim 16, further comprising instructions for transmitting, over the network, the set of available templates to a client computing device.

19. The server computing device of claim 16, further comprising instructions for transmitting, over the network, a representation of the set of available templates to a client device.

20. The server computing device of claim 16, further comprising instructions for:
receiving, over the network from a client computing device, a selection of a shared template from the set of available templates; and
providing access to the selected shared template.
